(19) United States
(12) Patent Application Publication
(10) Pub. No.: US 2006/0234008 A1
(43) Pub. Date: Oct. 19, 2006

(54) Composite system

(76) Inventors: Constantin Schwecke, Alfter (DE); Dieter Boesveld, Neuss (DE); Rudiger Utsch, Burbach (DE); Ulrich Leyrer, Leverkusen (DE); Peter Schwarz, Krefeld (DE)

Correspondence Address: BAYER MATERIAL SCIENCE LLC, 100 BAYER ROAD, PITTSBURGH, PA, 15205, US

(21) Appl. No.: 11/397,240

(22) Filed: Apr. 3, 2006

(30) Foreign Application Priority Data
Apr. 6, 2005 (DE) 102005015741.6

(51) Int. Cl. B32B 3/00

(52) U.S. Cl. 428/166

(57) ABSTRACT

A composite system having insulation properties is disclosed. The system includes a multi-wall profile and a thermal insulation element. The profile, made of a thermoplastic material includes a transparent upper plate and a radiation-absorbing lower plate that are joined together by webs; the webs extending in the longitudinal direction in such a manner that flow channels parallel one to the others are formed. The outer surface of the lower plate is joined to the thermal insulation element. The system is particularly suitable for use as solar collector.

### FIELD OF THE INVENTION

The invention relates to a composite system and in particular to a system that includes a multi-wall profile.

### TECHNICAL BACKGROUND OF THE INVENTION

DE 27 49 490A1 discloses a roofing and wall cladding material, in particular for thermally insulated house walls or roofs. This material consists of board-like plastics hollow profiles with a plurality of profile chambers which extend continuously in the longitudinal direction and edge profiles which may be slid into one another. The hollow profiles serve as roofing components. A heat-transfer medium, such as for instance air, flowing through the hollow profiles absorbs the heat from solar radiation, such absorption being promoted by the design of the multi-wall profile, and conveys it via a manifold or the like into the building.

DE 103 04 536 B3 discloses an improvement of the hollow profiles described in DE 27 49 490 A1. The upper part of the multi-wall profile for utilising solar energy according to DE 103 04 536 B3 is provided on its outside with an outer layer which consists of a plastic which absorbs the ultraviolet fraction of the radiation and is otherwise transparent. As a result, the upper part remains resistant to yellowing and turbidity and retains its mechanical strength over an extended period. The UV-absorbent outer layer is produced together with the upper and lower parts by the combination of two-component extrusion with coextrusion.

A disadvantageous feature of the multi-wall profile known from DE 103 04 536 B3 is the heat loss through the lower part on the side remote from the sun, this loss reducing efficiency of the solar collector. A further disadvantageous feature is the low rigidity of the hollow profiles, in particular in a length of several metres.

The object of the present invention is accordingly to provide a multi-wall profile of the type described in DE 103 04 536 B3, which exhibits lower heat loss, is more highly rigid and may simultaneously be produced and installed in a technically straightforward manner.

### BRIEF DESCRIPTION OF THE DRAWING

FIG. 1 shows a cross section of the inventive composite system.

### SUMMARY OF THE INVENTION

A composite system having insulation properties is disclosed. The system includes a multi-wall profile and a thermal insulation element. The profile, made of a thermoplastic material includes a transparent upper plate and a radiation-absorbing lower plate that are joined together by webs; the webs extending in the longitudinal direction in such a manner that flow channels for a heat-transfer medium parallel one to the others are formed. The outer surface of the lower plate is joined to the thermal insulation element. The system is particularly suitable for use as solar collector.

### DETAILED DESCRIPTION OF THE INVENTION

The present invention provides a composite system comprising a multi-wall profile of a thermoplastic material and a thermal insulation element, wherein the multi-wall profile comprise a transparent upper plate and a radiation-absorbing lower plate, which are joined together by webs extending in the longitudinal direction in such a manner that parallel flow channels are formed, and the outside surface of the lower plate is joined to the thermal insulation element.

The composite system according to the invention is suitable as a solar collector, for example on roofs or house walls.

A suitable heat-transfer medium is e.g. a gas, in particular air.

The multi-wall profiles known, for example, from DE 103 04 536 B3 are suitable as multi-wall profiles for the composite system according to the invention. The multi-wall profiles made from a thermoplastic material comprise a transparent upper plate and a radiation-absorbing lower plate , which are joined together by webs extending in the longitudinal direction in such a manner that parallel flow channels are formed.

When the composite system according to the invention is in service, the transparent upper plate faces towards the sun. In order to counteract yellowing and turbidity due to extended, intensive exposure to solar radiation, the outside of the upper plate may be provided with a UW-absorbing outer layer, preferably according to DE 103 04 536 B3. The outer layer is transparent in the visible wavelength range. In a further preferred embodiment in particular, as described in DE 103 04 536 B3, at least one thermotropic layer is provided, which is applied onto the UV-absorbing outer layer or onto the upper surface of the hollow profile. The transparency of the thermotropic layer is temperature-dependent in such a manner that, as the temperature rises, transparency decreases. In this manner, the hollow profile may be protected from exposure to excessively high temperatures.

The radiation-absorbing lower plate forms the absorption surface of the composite system used as a solar collector and in particular exhibits absorbency of at least 80% in the visible wavelength range of 300 to 800 nm. The lower plate with comparatively high absorbency must be capable of absorbing the largest possible amount of sunlight when the solar collector is in service. To this end, the lower plate is colored and/or coated for example with a black compound. A black color may, for example, be achieved by printing with black ink, coating with black chromium or black aluminium or by direct coloring of the plastics composition with suitable colorants, preferably carbon black.

Suitable thermoplastic materials for the multi-wall profile include polycarbonate, polymethyl methacrylate, polyolefins, polystyrene, polyethylene terephthalate and/or polyvinyl chloride. Polycarbonate is preferably used. The hollow profile is preferably manufactured in its totality from one of the stated plastics.

According to the invention, the thermal insulation element is joined to the outside of the lower plate. The thermal insulation element preferably comprises a mineral, thermoplastic, thermosetting or rubber-like material or a mixture of these materials, particularly preferably comprises mineral wool, rock wool, polystyrene and/or polyurethane in particular, polystyrene foam and/or polyurethane foam, very particularly preferably polyurethane foam.

The thermal insulation element may be of a thickness of 1 to 50 cm, depending on the nature of material for the thermal insulation element, the type and geometry of the building, legislative provisions and the desired thermal insulation properties. If the thermal insulation material used is polyurethane foam, the thickness in a preferred embodiment is 10 to 20 cm. In the embodiment with polyurethane, the preferred lambda value (λ value) of the thermal insulation is 0.015 to 0.05 W/m·K preferably, 0.015 to 0.040 W/m·K.

In a preferred embodiment, the thermal insulation element is delimited opposite to the multi-wall profile by an additional sheet, film or a combination of sheet and film. The sheet or film may be of wood, thermoplastic material, a thermosetting or rubber-like material, mineral, glass, metal or a combination of these materials. The sheet or film may be joined with the thermal insulation element by a material, non-interlocking or interlocking joint. Joining may for example, be accomplished by adhesion promoters, adhesives, hook and loop systems, insertion systems or cohesion-adhesion. The sheet and/or film serve for example, to provide a seal against humidity and/or increased mechanical stability of the composite system.

The thermal insulation element advantageously reduces heat loss through the lower part of the multi-wall profile and so increases the efficiency of the composite system used as a solar collector. The thermal insulation element moreover provides mechanical reinforcement, increasing rigidity and rendering the composite system self-supporting. The composite system enables straightforward installation in a preferred embodiment if a tongue and a groove are provided along side of the profile to enable a tongue and groove connection. In the tongue and groove connection an angle steel may be pinched which is mounted onto to a roof or a wall construction.

The multi-wall profile may be produced by extrusion, in particular by a combination of coextrusion and multi-component extrusion. After extrusion of the multi-wall profile, the lower part is mechanically, chemically or physically joined on its outside surface with the thermal insulation element. The thermal insulation element may be joined with the lower part of the multi-wall profile by a material, non-interlocking or interlocking joint. This may accomplished, for example, by adhesion promoters, adhesives, hook and loop systems, insertion systems or by cohesion-adhesion.

Production of the multi-wall profile and its joining to the thermal insulation element and the optional sheet and/or film on the surface remote from the hollow profile may be continuous or preferably in a discontinuous process in two or more separate steps. In a discontinuous process, the thermal insulation element is first joined to the multi-wall profile and the free surface of the element is optionally then joined with a sheet or film. If the thermal insulation element is produced from polyurethane, the polyurethane reaction mixture may be applied onto the multi-wall profile by means of a nozzle, after which it reacts to completion to yield the thermal insulation layer (e.g. a hard foam).

However, the composite system may for example also be produced by the joining with the thermal insulation element being provided directly downstream from the extrusion of the multi-wall profile at the outlet of the extrusion die or at a suitable distance from the extrusion die.

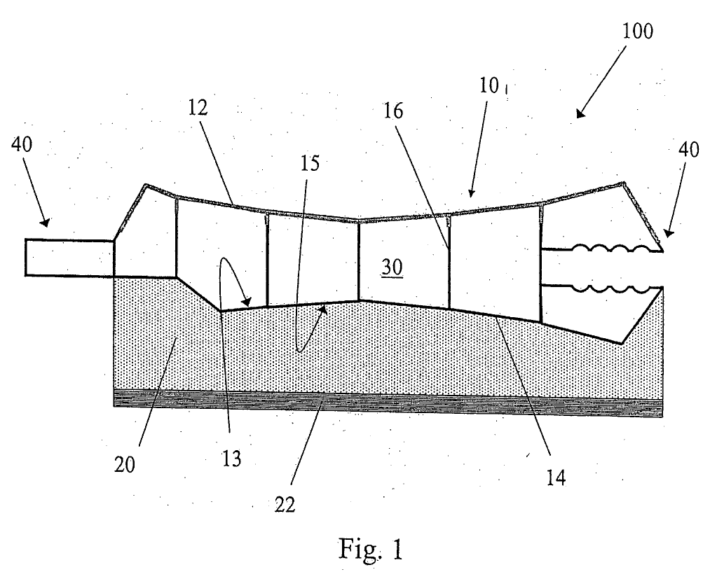

The invention is illustrated in greater detail in FIG. 1. FIG. 1 shows a cross-section through an embodiment of the composite system according to the invention. The composite system 100 comprises a multi-wall profile 10 and a thermal insulation element 20. The multi-wall profile 10 comprises a transparent upper plate 12 and a radiation-absorbing lower plate 14. The upper plate 12 and the lower plate 14 are joined together by webs 16 which extend in a longitudinal direction. The webs 16 are continuous and join the upper plate 12 and the lower plate 14 together in such a manner that continuous flow channels 30 which extend in the longitudinal direction are formed. When the composite system is in service as a solar collector, a heat-transfer medium, for example air, (not shown) flows through the flow channels 30. Air heated in the flow channels 30 can be passed through an external treat exchanger. The heat produced can be used for heating a building. Alternatively the heated air can be used for direct heating of a building. The thermal insulation element 20 is arranged on the outside 15 of the lower plate 14. It extends over the entire width and length of the multi-wall profile 10, in order to reduce heat loss via the lower plate 14. When the composite system 100 is in service as a solar collector, for example on a roof, the upper plate 12 forms the outside of the roof surface and thus faces towards the sun. Solar radiation passes through the transparent upper plate 12 onto the inner surface 13 of the lower plate 14. The lower plate 14 itself or its inner surface 13 forms the absorption surface of the solar collector. In other words, the lower plate 14 or a coating on the inner surface 13 of the lower plate 14 is radiation-absorbing, for example by the material being colored black, for example by carbon black. In the embodiment shown, the upper plate 12 and the lower plate 14 are curved concavely relative to one another. Alternatively, the upper plate 12 and/or the lower plate 14 may also be provided without a curve. In the embodiment shown, the thermal insulation element 20 is delimited on the opposite side to the hollow profile 10 by a metal sheet 22.

In the embodiment shown, tongue and groove of a tongue-and-groove joint 40 are provided for joining two composite systems 100 together. Two or more juxtaposed hollow profiles may also be joined together by one or more common thermal insulation elements by the hollow profiles being foamed together.

### EXAMPLE

A composite system was produced from a multi-wall profile 10 of polycarbonate (Makrolon®, from Bayer MaterialScience AG, Germany) and a thermal insulation element 20 of polyurethane foam (raw material VP.PU 28 HS88/Desmodur 44V20L and polyol system 28HS88, from Bayer MaterialScience AG, Germany). The multi-wall profile 10 included of a transparent upper plate 12 and a radiation-absorbing lower plate 14, which were joined to one another by webs 16 running in a longitudinal direction. The lower plate 14 was colored with carbon black and had an absorbency of about 80% in the visible wavelength range of 300 to 800 nm. The thermal insulation element 20 had a thickness of 5 cm.

The multi-wall profile was produced by a combination of coextrusion and multi-component extrusion. The thermal insulation element was joined with the multi-wall profile by adhesion.

It was found that the thermal insulation of the above described composite system has been improved by a factor of 40 relative to the multi-wall profile without the thermal insulation layer.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A composite system comprising a multi-wall profile made of a thermoplastic material and a thermal insulation element, said multi-wall profile including a transparent upper plate, and a radiation-absorbing lower plate, joined together by a plurality of parallel webs positioned parallel one to the others, extending longitudinally and forming flow channels for a heat-transfer medium, wherein the outer surface of the lower plate is joined to said thermal insulation element.

2. The composite system according to claim 1 wherein the thermal insulation element comprising at least one material selected from the group consisting of mineral, thermoplastic resin, thermosetting resin and an elastomer.

3. The composite system according to claim 1 wherein the thermal insulation element includes a member selected from the group consisting of mineral wool, rock wool, polystyrene and polyurethane in particular polystyrene foam and polyurethane foam.

4. The composite system according to claim 1 wherein the thermoplastic material is a member selected from the group consisting of polycarbonate, polymethyl methacrylate, polyolefins, polystyrene, polyethylene terephthalate and polyvinyl chloride.

5. The composite system according to claim 1 wherein the thermal insulation element is joined on its surface remote from the multi-wall profile with a sheet and/or film.

6. The composite system according to claim 5 wherein the sheet and/or film contains at least one material selected from the group consisting of wood, thermoplastic material, thermosetting material, elastomeric material, glass, metal, and mineral substance.
